(19) United States
(12) Patent Application Publication
(10) Pub. No.: US 2023/0191654 A1
(43) Pub. Date: Jun. 22, 2023

(54) METHOD FOR PRODUCING A PREFABRICATED 3D-PRINTED PART

(71) Applicant: Progress Maschinen & Automation AG, Brixen (IT)

(72) Inventors: Kurt WOHLGEMUTH, Sarthein (IT); Karl ENDERES, Brixen (IT)

(21) Appl. No.: 18/108,337

(22) Filed: Feb. 10, 2023

Related U.S. Application Data
(63) Continuation of application No. PCT/EP2021/072530, filed on Aug. 12, 2021.

(30) Foreign Application Priority Data
Aug. 13, 2020 (AT) A 50678/2020

(51) Int. Cl. B28B 1/00; E04B 1/16; B33Y 30/00; B33Y 10/00

(52) U.S. Cl. CPC B28B 1/001; E04B 1/16; B33Y 30/00; B33Y 10/00

(57) ABSTRACT

A method for producing a prefabricated 3D-printed part includes depositing a layer of a particulate aggregate on a production panel by a layer-depositing device; and dispensing a predetermined dose of a binder or a water/binder mixture, comprising water and at least one hydraulic binder, onto a locally predetermined region of the layer of the aggregate by a printhead. At least one reinforcement is arranged by a reinforcement-depositing device, at least in some regions, on and/or in the locally predetermined region on which the predetermined dose of the binder or the water/binder mixture was dispensed during the course of the second method step.

### BACKGROUND OF THE INVENTION

The invention relates to a method for producing a prefabricated 3D-printed part, preferably a concrete prefabricated component, for the construction industry, comprising the following method steps: in a first method step at least one layer of at least one particulate aggregate is deposited on a production pallet by at least one layer depositing device, and in a second method step a predetermined dose of at least one binder or at least one water-binder mixture is delivered at at least one locally predetermined region of the at least one layer of the at least one aggregate by at least one printhead. The invention furthermore relates to a plant for carrying out such a method.

Methods for producing a prefabricated 3D-printed part are known from the state of the art. Thus, a method which is called Selective Cement Activation (SCA) is known. In it, a base material is mixed with a first binder component and applied in powdered form. A second binder component is then applied in liquid form at the locally predetermined regions, wherein a solidification of the base material is effected through a reaction of the two binder components. A further known method is called Selective Paste Intrusion (SPI). In it, a base material, such as e.g. sand, brick chips, Liapor or expanded clay, but which is not mixed with a binder is used. In this case, a solidification is effected through the application of a water-binder mixture.

The disadvantage of these methods is that the prefabricated parts producible with them have a low stability, which is very rarely sufficient in the construction industry.

A method which is called “contour crafting” is furthermore known from the state of the art. In it, there are approaches for increasing the stability of the components manufactured with it through strengthening cables. However, it was possible, by experiments using pull tests and additionally made visual and microscopic observations, to ascertain that chemical interactions between the mortar and the strengthening cables impair the bonding quality. Furthermore, the stability of the components produced by contour crafting in which strengthening cables are incorporated is generally lower than the stability of cast concrete prefabricated parts. This is probably to be attributed to the lack of compaction as well as the flowing of the mortar around the strengthening cables, which results in cavities under the cables. Moreover, the stability decreases as the length of the embedded strengthening cables increases.

### SUMMARY OF THE INVENTION

The object of the present invention is to at least partially remedy these disadvantages and to specify a method, improved compared with the state of the art, for producing a prefabricated 3D-printed part for the construction industry, wherein the prefabricated parts producible by the method in particular have a sufficiently high stability. A plant for carrying out a method improved in such a way is also to be specified.

In the method according to the invention, it is thus provided that in a third method step at least one reinforcement is arranged, by at least one reinforcement depositing device, at least in regions on and/or in at least the at least one locally predetermined region, at which the predetermined dose of the at least one binder or the at least one water-binder mixture was delivered in the course of the second method step.

Of course, reinforcements are already known per se in the field of the production of concrete prefabricated components. However, in the field of the known printing methods, there was the preconception that these printing methods are not compatible with such reinforcements.

The present invention radically challenges this preconception. It was in no way foreseeable for a person skilled in the art that it would be possible to integrate conventional reinforcements in the prefabricated part to be printed in the course of a printing process.

Not only do the prefabricated parts producible by the method according to the invention have a significantly increased stability compared with the prefabricated parts producible by the known printing methods. The method according to the invention also has a number of advantages compared with production methods in which wet concrete is processed into concrete prefabricated components with the aid of formwork elements:
expensive and complex stations, such as formwork robots, and the associated formwork parts and magnets can be dispensed with;
flat elements, such as wall elements or ceiling elements, can be produced accurately fitting and without formwork effort;
window block-outs can be achieved without formwork effort;
any desired free forms can be achieved;
post-formwork operations and the use of non-recyclable material can be dispensed with entirely;
openings and slits, printed “conduits” and printed “sockets” for electric and sanitary equipment can be provided for directly without additional effort and the use of plastics;
weight-reducing cavities can be printed directly;
no additional compaction is needed, as the application of the particulate aggregate is effected in layers;
a low water-cement factor is possible, which results in a minimal consumption of cement;
the production can be effected on a mobile production pallet;
as an alternative or supplement to this, a production in which several production pallets are provided in series and the at least one printhead and the at least one layer depositing device are moved over the production pallets is possible;
production on a long track is equally possible, wherein in this case the at least one printhead and the at least one layer depositing device are also moved over the production pallets;
a production within the framework of a circulation plant can be achieved, whereby drying racks, lift stations with and without tilting device, cleaning station, oiling station from the standard program of a circulation supplier and standard guidance and control systems of a circulation plant can be used;
the degree of automation can be further increased, namely from design to production;
the planning of a concrete prefabricated component proves to be simpler, as a fully digitized planning for a batch size of 1 is possible;
complex planning operations are dispensed with;
less storage space is needed for consumables.

With regard to the aspect of reinforcements, the method according to the invention is characterized, compared with production methods in which wet concrete is processed into concrete prefabricated components with the aid of formwork elements, by the following advantages:
no spacers for the reinforcement made of plastic are needed;
protruding reinforcements are possible without problems, whereas protruding reinforcements can be achieved by formwork elements, if at all, only with a very great effort;
lattice girders, connecting rods or other vertical reinforcement systems can be easily pushed in.

The method according to the invention is in principle compatible with both an SCA and an SPI printing process. According to a preferred embodiment, an SPI printing process is used. This has a number of advantages compared with an SCA printing process:
the powder bed only consists of particulate aggregates, such as e.g. sand, brick chips, Liapor, expanded clay, which have been known in the construction industry for decades;
various materials, such as e.g. insulation materials, can be easily used;
the base material is not mixed with a binder, which has the result that an unbound material can be easily re-used;
the water-binder mixture is selectively applied, not activated;
if cement is used in the water-binder mixture, residues can be easily broken, sieved and used again;
the print volume available need not be optimally filled;
a complex unpacking station with extraction systems is not necessary, as the dust formation is significantly less;
an application of one or more first and last layers of the water-binder mixture opens up the possibility of smooth surfaces which can otherwise be achieved only by a formwork or by a screeding, but in no case by an SCA printer;
the particulate aggregates that can be used are resistant to water;
the components that can be produced have a much higher strength
Portland cement can be used, with the result that valid authorizations and standards can be utilized;
the material costs are lower.

If an SPI printing process is used, it is appropriate that in the course of the second method step at least one water-binder mixture, comprising water and at least one hydraulic binder, in particular a cement-based binder, is delivered, and the dose of the at least one water-binder mixture delivered is large enough that a liquefaction at least in regions is achieved at the at least one locally predetermined region of the at least one layer of the at least one aggregate. An ideal condition is thereby created for sinking, preferably by pressing, shaking and/or vibration, the reinforcement into the locally predetermined region of the at least one layer at least in regions in the course of the subsequent third method step.

As stated at the beginning, protection is also sought for a plant for carrying out the method according to the invention, wherein the plant comprises at least one 3D printing station with at least one layer depositing device for depositing, in layers, at least one particulate aggregate on the at least one production pallet and at least one printhead for the controlled delivery of at least one binder or at least one water-binder mixture, comprising water and at least one hydraulic binder, in particular a cement-based binder, at at least one locally predetermined region of the production pallet and/or a layer of the at least one aggregate deposited on the production pallet by the at least one layer depositing device, and at least one reinforcement depositing device, with which at least one reinforcement can be arranged at least in regions on and/or in at least the at least one locally predetermined region, at which the predetermined dose of the at least one binder or the at least one water-binder mixture was delivered in the course of the second method step.

### BRIEF DESCRIPTION OF THE DRAWINGS

Further details and advantages of the invention are explained in more detail below with the aid of the description of the figures with reference to the drawings. There are shown in:

FIG. 1 shows a first embodiment of a plant for producing a concrete prefabricated component in a schematically represented view,

FIG. 2 shows a first embodiment of a 3D printing station in a schematically represented perspective view,

FIGS. 3a, b show two further embodiments of a 3D printing station in a schematically represented top view,

FIGS. 4a, b show two further embodiments of a plant for producing a concrete prefabricated component in schematically represented views,

FIG. 5 is a diagram of a further embodiment of a 3D printing station with the associated supply loops in a schematically represented view,

FIG. 6 is a diagram of a first embodiment of a print bar in a schematically represented view,

FIGS. 7a-d shows a first embodiment of a method for producing a prefabricated 3D-printed part for the construction industry in schematically represented perspective views,

FIG. 8 shows a further embodiment of a printed concrete prefabricated component in a schematically represented perspective view,

FIGS. 9a, b show further embodiments of a printed concrete prefabricated component in schematically represented perspective views,

FIG. 10 shows a further embodiment of a printed concrete prefabricated component in the form of a double wall in a schematically represented perspective view,

FIG. 11 shows a further embodiment of a printed concrete prefabricated component with an insulation layer in a schematically represented perspective view,

FIG. 12 shows a further embodiment of a printed concrete prefabricated component with printed block-outs and in-wall conduits for electrical wires in a schematically represented perspective view,

FIGS. 13a, b show a first embodiment of a production pallet in a schematically represented top view,

FIGS. 14a, b show a further embodiment of a production pallet in a schematically represented top view in sub-figure a and in a cross-sectional view from the side in sub-figure b,

FIG. 15 shows a further embodiment of a production pallet with two printed regions in a schematically represented top view,

FIG. 16 shows a further embodiment of a production pallet and a layer depositing device in a schematically represented cross-sectional view from the side,

FIG. 17 shows a further schematically represented embodiment of a concrete prefabricated component in a perspective view,

FIG. 18 shows an embodiment of a print bar and a layer depositing device of a 3D printing station in a schematically represented cross-sectional view from the side,

FIG. 19 shows a schematically represented embodiment of a printhead for the controlled delivery of a water-binder mixture in a perspective view,

FIG. 20a shows the embodiment of the printhead represented in FIG. 19, wherein a first partial body of a removable body has been hidden,

FIG. 20b shows the embodiment of the printhead represented in FIG. 19, wherein a first and a second partial body of a removable body have been hidden,

FIG. 21a shows the embodiment of the printhead represented in FIG. 19 in a perspective side view,

FIG. 21b shows the embodiment of the printhead represented in FIG. 21a, wherein a first and a second partial body of a removable body have been hidden,

FIG. 22a shows a schematically represented embodiment of an arrangement with a water-binder mixture, comprising water and at least one hydraulic binder, in particular a cement-based binder, and a printhead for the controlled delivery of the water-binder mixture in a cross-sectional view along a cross-sectional plane parallel to a longitudinal axis of the printhead,

FIG. 22b shows the embodiment of the printhead represented in FIG. 19 in a cross-sectional view along a cross-sectional plane perpendicular to a longitudinal axis of the printhead,

FIG. 23 shows a schematically represented embodiment of a valve of a printhead for the controlled delivery of a water-binder mixture in a perspective view,

FIGS. 24a, b show an isolated representation of a valve rod of the valve represented in FIG. 23 and a nozzle body, wherein the valve rod and the nozzle body are in contact in sub-figure a and the valve rod and the nozzle body are spaced apart from each other in sub-figure b,

FIG. 25 is an isolated representation of a valve rod of the valve represented in FIG. 23, and

FIG. 26 is an isolated representation of a nozzle body of the valve represented in FIG. 23.

### DETAILED DESCRIPTION OF THE INVENTION

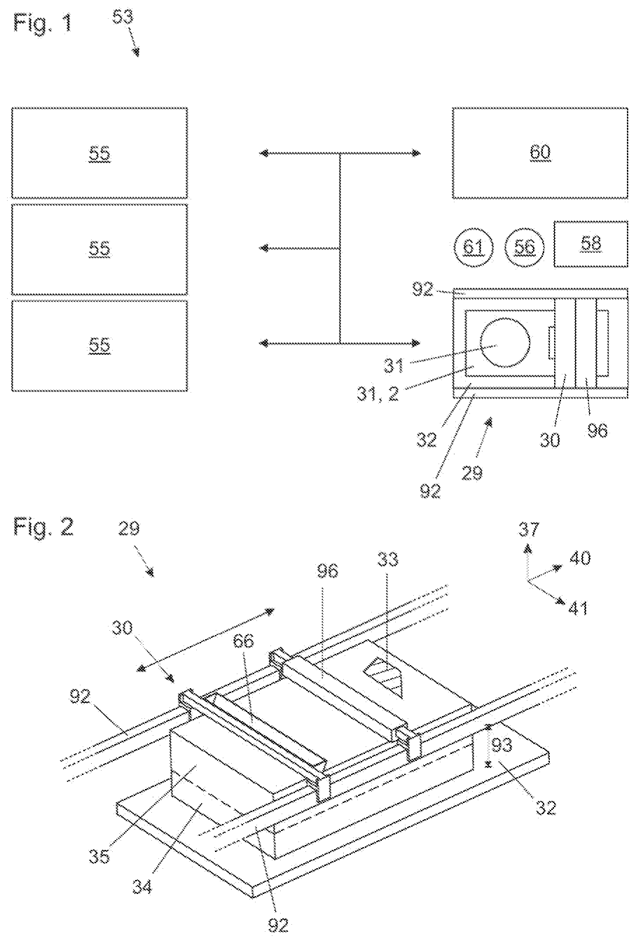

FIG. 1 shows a first embodiment of a plant 53 for producing a, preferably flat, concrete prefabricated component 54, comprising several stations, through which at least one production pallet 32 can pass, wherein the plant 53 comprises at least one transport system, with which the at least one production pallet 32 can be transported through the plant 53. The transport routes, covered in the process, between the stations are indicated by arrows.

The plant 53 furthermore comprises at least one 3D printing station 29 with at least one layer depositing device 30 for depositing, in layers, at least one particulate aggregate 31 on the at least one production pallet 32 and at least one printhead 1 for the controlled delivery of at least one water-binder mixture 2, comprising water and at least one hydraulic binder, in particular a cement-based binder, at at least one locally predetermined region 33 of the production pallet 32 and/or a layer 34, 35, 36 of the at least one aggregate 31 deposited on the production pallet 32 by the at least one layer depositing device 30.

At least one storage device 56 is provided, in which the at least one particulate aggregate 31 can be stored.

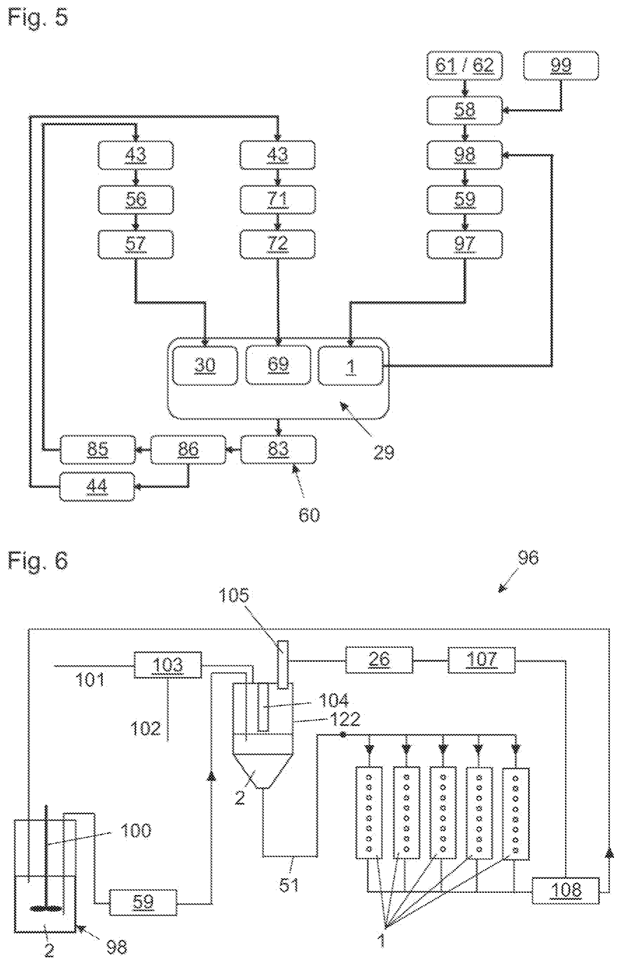

As follows from FIG. 5, at least one conveying device 57 can be provided, with which the at least one particulate aggregate 31 stored in the at least one storage device 56 can be conveyed to the at least one layer depositing device 30 of the at least one 3D printing station 29.

The plant 53 furthermore comprises at least one mixing device 58, with which the at least one water-binder mixture 2 can be provided.

As follows from FIG. 5, at least one feed device 59 can be provided, with which the at least one water-binder mixture 2 provided by the at least one mixing device 58 can be fed to the at least one printhead 1 of the at least one 3D printing station 29.

The plant 53 comprises at least one unpacking station 60, in which a concrete prefabricated component 54 printed on the at least one production pallet 32 in the at least one 3D printing station 29 can be unpacked from an unbound particulate aggregate 31.

And finally in the specifically represented embodiment the plant 53 comprises holding areas 55 for the at least one production pallet 32.

A substantial advantage of the plant 53 is that formworks and the associated formwork management, such as e.g. a formwork robot, a cleaning station or a magazine, can be dispensed with. There is also no need for a concrete spreader and a smoothing device, which are used in conventional circulation plants for producing concrete prefabricated elements.

By such a plant 53, a method for producing a, preferably flat, concrete prefabricated component 54 can be carried out as follows:

In the at least one 3D printing station 29, at least one layer 34, 35, 36 of the at least one particulate aggregate 31 is deposited on the production pallet 32 by the at least one layer depositing device 30 in a first printing method step and a predetermined dose 49 of the at least one water-binder mixture 2 is delivered at at least one locally predetermined region 33 of the at least one layer 34, 35, 36 of the at least one aggregate 31 by the at least one printhead 1 in a second printing method step, preferably wherein the two printing method steps are repeated and/or carried out in reverse order.

It can be provided that at least one outside of the concrete prefabricated component 54 is provided with a predetermined surface structure in the course of the printing method steps. This represents a great advantage compared with conventional production methods, as expensive shaping rubber matrices can be dispensed with. Instead, the predetermined surface structure, thus e.g. a desired pattern, is printed.

The at least one particulate aggregate 31 is conveyed from the at least one storage device 56 to the at least one layer depositing device 30 of the at least one 3D printing station 29 by the at least one conveying device 57.

The at least one water-binder mixture 2 is provided in the at least one mixing device 58 and fed to the at least one printhead 1 of the at least one 3D printing station 29 by the at least one feed device 59.

The at least one production pallet 32 is transported from the at least one 3D printing station 29 to the at least one unpacking station 60 by the at least one transport system, and a concrete prefabricated component 54 printed on the at least one production pallet 32 in the at least one 3D printing station 29 is unpacked from an unbound particulate aggregate 31 in the at least one unpacking station 60.

If the plant 53, as in the case represented, has holding areas 55 for the at least one production pallet 32, the at least one production pallet 32 is transported from the at least one holding area 55 to the at least one 3D printing station 29 by the at least one transport system in a further method step.

FIG. 2 shows a first embodiment of a 3D printing station 29.

The 3D printing station 29 has at least two guide rails 92, on which the at least one layer depositing device 30 and/or the at least one printhead 1 are movable in a plane parallel to the at least one production pallet 32.

The 3D printing station 29 can comprise at least one height-adjustment device, with which a distance 93 of the at least one layer depositing device 30 or a part of the at least one layer depositing device 30 and/or the at least one printhead 1 from a production pallet 32 arranged in the at least one 3D printing station 29 is alterable in the vertical direction 37 depending on a print advancement.

The at least one printhead 1 and the at least one layer depositing device 30 have a longitudinal extent in direction 41 and are movable in a direction 40 transverse thereto along the guide rails 92, which is indicated by a double arrow. The at least one printhead 1 or constituents of same and/or the at least one layer depositing device 30 or constituents of same can also be movable in direction 41. It is also possible to provide more than one layer depositing device 30 and/or more than one printhead 1. The print speed can thereby be increased.

By the layer depositing device 30, layers 34, 35 of at least one particulate aggregate 31 can be deposited on the production pallet 32. With the aid of the printhead 1, a predetermined dose of a binder or of a water-binder mixture 2, comprising water and at least one hydraulic binder, in particular a cement-based binder, can be delivered in a controlled manner at at least one locally predetermined region 33 of the production pallet 32 (for the case where no layer of the particulate aggregate 31 has yet been deposited on the production pallet 32) or a layer 34, 35 of the at least one aggregate 31 deposited on the production pallet 32 by the layer depositing device 30.

The layer depositing device 30 can, as in the case represented, have a depositing funnel 66 as intermediate storage for the at least one particulate aggregate 31.

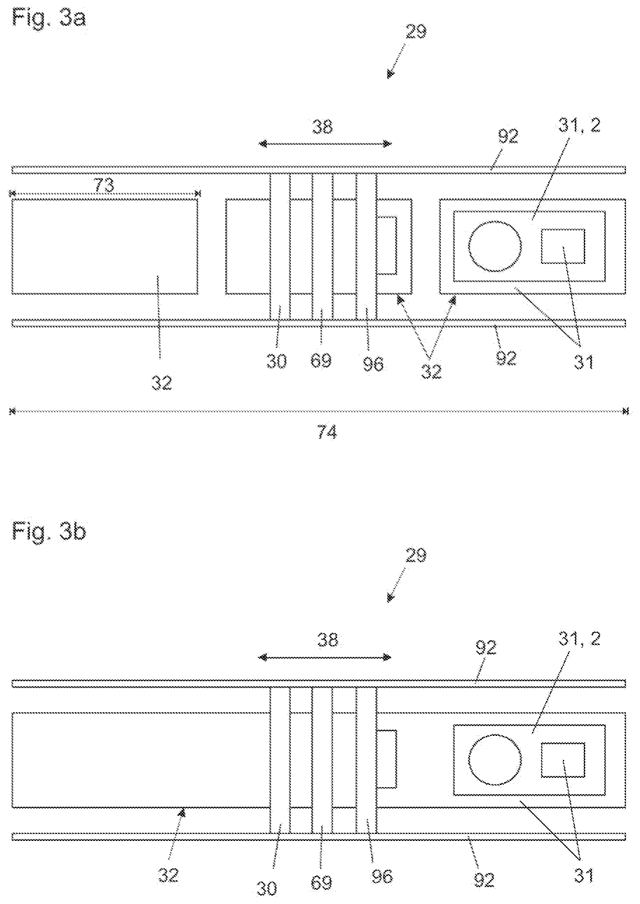

FIGS. 3a and 3b show two further embodiments of a 3D printing station 29 in a schematically represented top view, wherein the two embodiments differ in that several shorter production pallets 32, which can be arranged in series one behind another in the printing station 29, are used in the case of FIG. 3a and a long production pallet 32, on which several prefabricated components can be printed, is used in the case of FIG. 3b. The print direction 38 is marked with an arrow.

The plant 53 thus comprises at least one production pallet 32 which has a length 73, and the at least one 3D printing station 29 has a length 74, particularly preferably wherein the length 74 of the at least one 3D printing station 29 is at least twice as large as the length 73 of the at least one production pallet 32.

In comparison with the embodiment of FIG. 2, the at least one 3D printing station 29 comprises at least one further layer depositing device 69 for depositing, in layers, at least one insulation material 70, preferably wherein the plant 53 comprises at least one further storage device 71, in which the at least one insulation material 70 can be stored, and at least one further conveying device 72, with which the at least one insulation material 70 stored in the at least one further storage device 71 can be conveyed to the at least one further layer depositing device 30 of the at least one 3D printing station 29 (cf. also FIG. 5). In this connection, it is appropriate that the plant 53 also comprises at least one suction device for extracting unbound particulate aggregate 31.

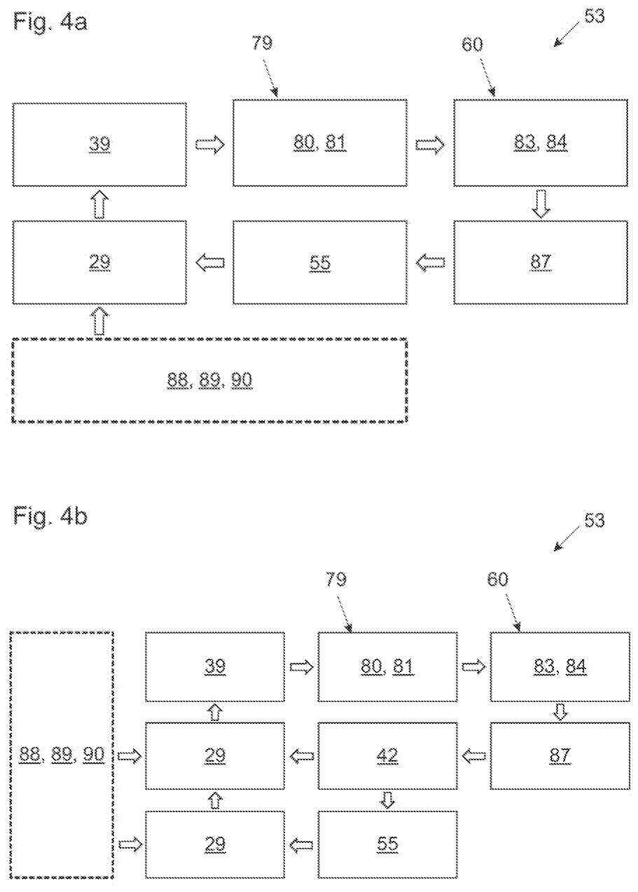

FIGS. 4a and 4b show two further embodiments of a plant 53 for producing a concrete prefabricated component. The plants 53 are designed as circulation plants, in which one or more production pallets 32 pass through the stations of the plant 53 in a circulating manner by a suitable transport system.

The plants 53 in each case have one or more holding areas 55. These can serve as intermediate storage for empty production pallets 32. From there, the production pallets 32 can be transported to one or more 3D printing stations 29. A central traverser 42 can be provided for the management of several holding areas 55.

Optionally, at least one straightening machine 88, at least one reinforcement welding device 89 and/or at least one reinforcement depositing device 90, with which at least one reinforcement 91 can be arranged on the at least one production pallet 32 arranged in the at least one 3D printing station 29, can be provided.

The plants 53 in each case have at least one drying station 79, in which the at least one production pallet 32 can be arranged in order to cure a concrete prefabricated component 54 printed on the at least one production pallet 32 in the at least one 3D printing station 29, wherein the at least one drying station 79 comprises at least one heating device 80 and at least one pallet rack 81 in order to arrange at least two production pallets 32 one above another in the at least one drying station 79. The drying station 79 is arranged after the at least one 3D printing station 29 in the production direction.

A stacker crane 39 can be provided for the operation of the pallet rack 81.

Following the drying station 79, the production pallets 32 can be transported into an unpacking station 60. This can comprise at least one tilting device 83, and/or at least one removal device 84 for removing the unbound particulate aggregate 31.

And finally in the embodiments shown the plants 53 in each case have at least one preparation station 87 for preparing the at least one production pallet 32, preferably wherein the at least one preparation station 87 comprises at least one cleaning agent and/or release agent spraying device.

As in the first embodiment according to FIG. 1, the plants 53 are formed without formwork robots.

FIG. 5 shows a diagram of a further embodiment of a 3D printing station 29 with the associated supply loops.

The water-binder mixture 2 that can be delivered by the at least one printhead 1 in this case comprises water and at least one cement-based binder. The associated plant 53 comprises at least one cement storage device 61, in which cement can be stored, and/or at least one bag loading station 62 for cement bags, wherein the at least one cement storage device 61 and/or the at least one bag loading station 62 are in cement-channeling connection with the at least one mixing device 58, with which the at least one water-binder mixture 2 can be provided.

Via a superplasticizer doser 99, at least one superplasticizer can be fed, metered, to the mixing device 58.

Following the mixing device 58, an equalizing tank 98 can be arranged, from which on the one hand the water-binder mixture 2 can be fed to at least one printhead 1 via a filter 97 by a feed device 59, e.g. in the form of a pump. On the other hand, water-binder mixture 2 that has not been applied can be fed back from the printhead 1 into the equalizing tank 98 again. It is important that the water-binder mixture 2 always remains in motion.

The layer depositing device 30 of the 3D printing station 29 is supplied with the particulate aggregate 31 to be applied from a storage device 56 by a conveying device 57, e.g. in the form of a pump. This aggregate 31 can be for sand and/or expanded clay.

Optionally, the 3D printing station 29 can comprise a further layer depositing device 69 e.g. for applying an insulation material 70. This can analogously be supplied via a further storage device 71 and a further conveying device 72, e.g. a pump.

The supply loops of the two layer depositing devices 30 and 69 can be completed by the at least one unpacking station 60. This can have at least one separating device 86 for separating the at least one particulate aggregate 31 from at least one further substance applied to the at least one production pallet 32 by the at least one 3D printing station 29, preferably wherein the at least one separating device 86 comprises at least one sieve and/or at least one air separator.

The substances separated from each other in such a way can then be fed back into the storage devices 56 and 71, which can be e.g. a silo, in each case by a recirculation device 44 or 85 and in each case a sieve 43. The recirculation devices 44 or 85 can comprise e.g. a pump, an extraction system and/or a transport system.

FIG. 6 shows a diagram of a first embodiment of a print bar 96. The print bar 96 comprises several, e.g. five, printheads 1, which can be supplied with the water-binder mixture 2 in parallel via lines 51.

The supply loop comprises an equalizing tank 98. A mixing propeller 100 can be arranged in the latter.

By a feed device 59, the water-binder mixture 2 can be conveyed into an intermediate tank 122. This can have a flushing nozzle 104.

Furthermore, the intermediate tank 122 can be coupled with a quick exhaust valve 103, with which air can be removed from the intermediate tank 122 in an emergency, e.g. a blockage. The reference number 101 denotes the nozzle pressure, the reference number 103 denotes the outlet of the quick exhaust valve.

For pressure regulation, a pinch valve 108, a pressure regulator 107 and a level sensor 105 can be provided, which are or can be connected to a control and/or regulating device 26.

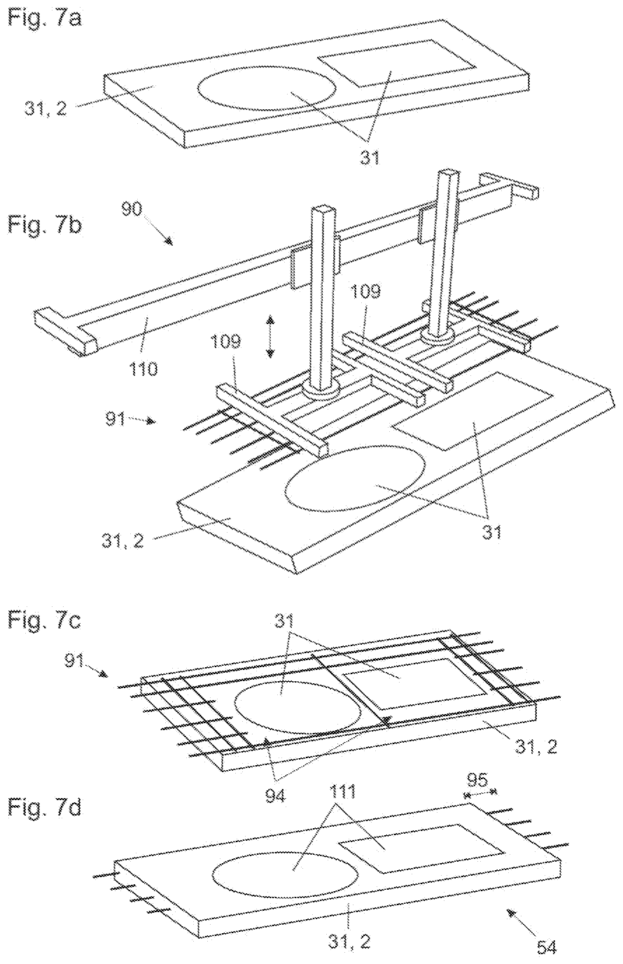

FIGS. 7a to 7d show, in four sub-steps, a first embodiment of a method for producing a prefabricated 3D-printed part, preferably concrete prefabricated component 54, for the construction industry.

The method has the following method steps:

In a first method step at least one layer 34, 35, 36 of at least one particulate aggregate 31 is deposited on a production pallet 32 by at least one layer depositing device 30.

In a second method step a predetermined dose 49 of at least one binder or at least one water-binder mixture 2 is delivered at at least one locally predetermined region 33 of the at least one layer 34, 35, 36 of the at least one aggregate 31 by at least one printhead 1.

In a third method step at least one reinforcement 91 is arranged, by at least one reinforcement depositing device 90, at least in regions on and/or in at least the at least one locally predetermined region 33, at which the predetermined dose 49 of the at least one binder or the at least one water-binder mixture 2 was delivered in the course of the second method step.

In the course of the third method step at least one reinforcement 91 can be arranged in the form of a reinforcement mesh, preferably made of steel and/or plastic, or in the form of fibers, preferably glass fibers.

The first and second method steps can be repeated at least once after the third method step, and/or the first and second method steps can be carried out in reverse order.

The at least one reinforcement 91 can have at least one block-out 94 in at least one region of the at least one layer 34, 35, 36 of the at least one aggregate 31, in which the at least one binder or the at least one water-binder mixture 2 was not delivered.

In the course of the third method step the reinforcement 91 can be sunk, preferably by pressing and/or vibration, at least in regions into the locally predetermined region 33 of the at least one layer 34, 35, 36 of the at least one particulate aggregate 31, in which the predetermined dose 49 of the at least one binder or the at least one water-binder mixture 2 was delivered.

The reinforcement 91 can also be sunk in over several print layers in the course of the third method step. The reinforcement 91 also need not be completely sunk. A protrusion from the top, e.g. of 1-2 cm, is also possible.

In the course of the third method step the at least one reinforcement 91 can be arranged such that the at least one reinforcement 91 has a lateral protrusion 95 beyond a side of the at least one layer 34, 35, 36 of the at least one particulate aggregate 31. Such protrusions, which serve in particular to connect the components to further components, can only be achieved with an enormous effort in conventional plants, in which formworks are used.

After the prefabricated part 54 produced has been unpacked from loose, unbound particulate aggregate 31, printed openings 111, achieved without formworks, remain, e.g. as window block-outs.

In FIG. 7b a reinforcement depositing device 90 is represented schematically, with which the at least one reinforcement 91 can be arranged at least in regions on and/or in at least the at least one locally predetermined region 33, at which the predetermined dose 49 of the at least one binder or the at least one water-binder mixture 2 was delivered in the course of the second method step. The reinforcement depositing device 90 can have e.g. two grippers 109, which are mounted movably along a carrier 110.

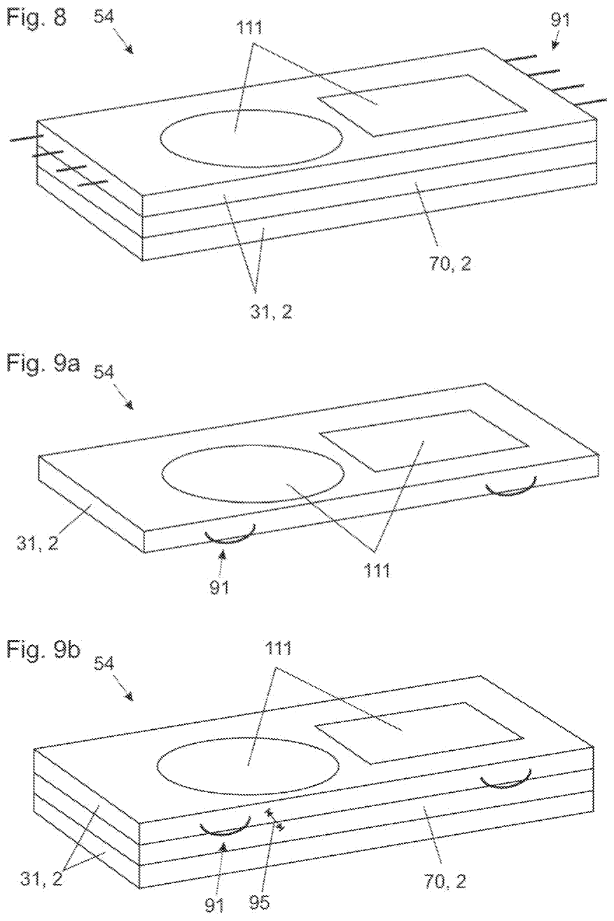

FIG. 8 shows a further embodiment of a printed concrete prefabricated component 54, which has, in addition to an upper layer which corresponds to the concrete prefabricated component 54 represented in FIG. 7d, a lower layer without reinforcement 91 and a layer arranged in between made of an insulation material 70 printed with it.

FIGS. 9a and 9b show further embodiments of a printed concrete prefabricated component 54, in which reinforcements 91 in the form of lifting anchors are incorporated. These can be arranged, as represented, standing out or sunk in a printed pocket.

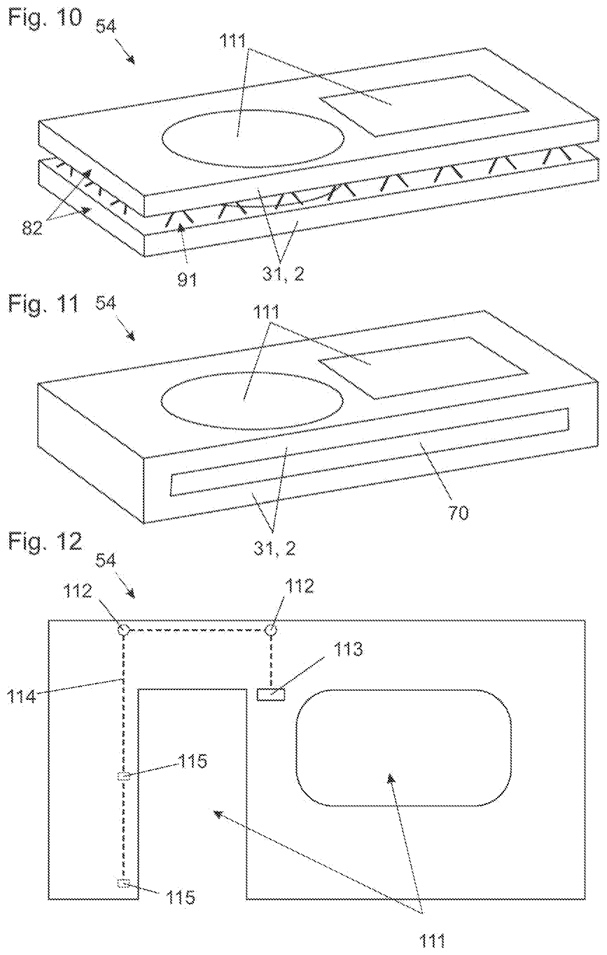

FIG. 10 shows a further embodiment of a printed concrete prefabricated component 54 in the form of a double wall. The double wall has two side elements 82 spaced apart from each other which are connected to each other via at least one reinforcement 91.

The two side elements 82 can either be printed separately on two production pallets 32 and then joined together or be printed in the course of a single printing process on one production pallet 32.

FIG. 11 shows a further embodiment of a printed concrete prefabricated component 54 with a layer made of insulation material 70. In this case, it is a loose, i.e. unbound, insulation material.

The concrete prefabricated component 54 can be produced in that in a further method step unbound particulate aggregate 31 is removed, preferably extracted, at least in one region and in a further method step at least one insulation material 70 is deposited by at least one further layer depositing device 30 in the region in which the unbound particulate aggregate 31 was removed.

The sides of the concrete prefabricated component 54 can be closed by printed side walls or other measures, so that the loose insulation material 70 cannot leak out of the concrete prefabricated component 54.

FIG. 12 shows a further embodiment of a printed concrete prefabricated component 54 with printed block-out 112 for in-wall sockets, block-out 113 for a roller blind control, block-outs 114 for in-wall electrical wires and block-outs 115 for switches.

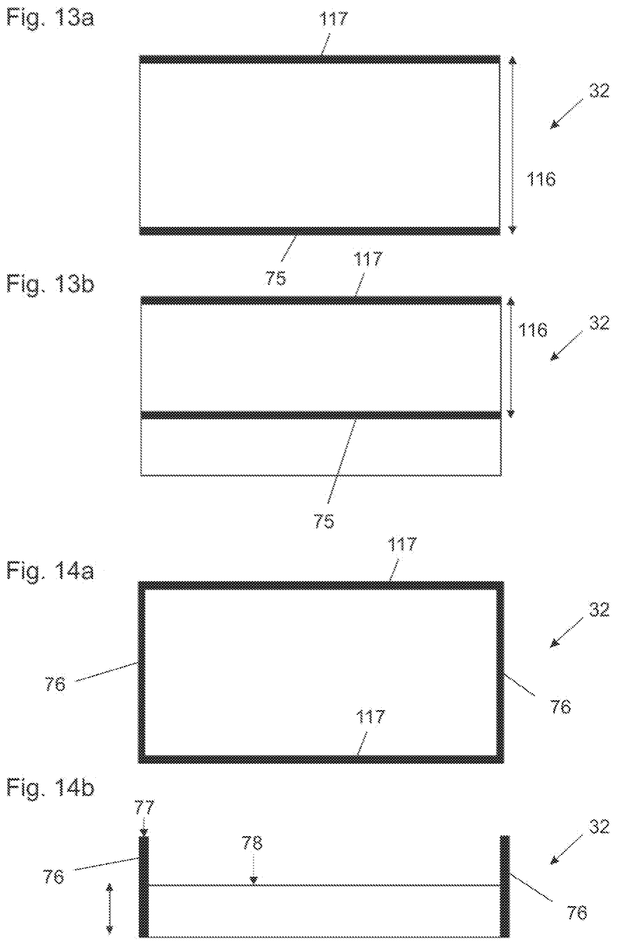

FIGS. 13a and 13b show a first embodiment of a production pallet 32, which comprises a fixed side limit 117 and a, e.g. manual, side limit 75. In this way, a width 116 of the printable region can be altered. This can make sense for example when a smaller prefabricated component is to be printed.

FIGS. 14a and 14b show a further embodiment of a production pallet 32, wherein the production pallet 32 comprises two height-adjustable side limits 76, wherein the height-adjustable side limits 76 can in each case be brought into a first position on the production pallet 32, in which the side limits 76 laterally delimit a volume that can be printed on the production pallet 32, and into at least one second position, in which a top 77 of the side limits 76 is substantially aligned with a top 78 of the production pallet 32.

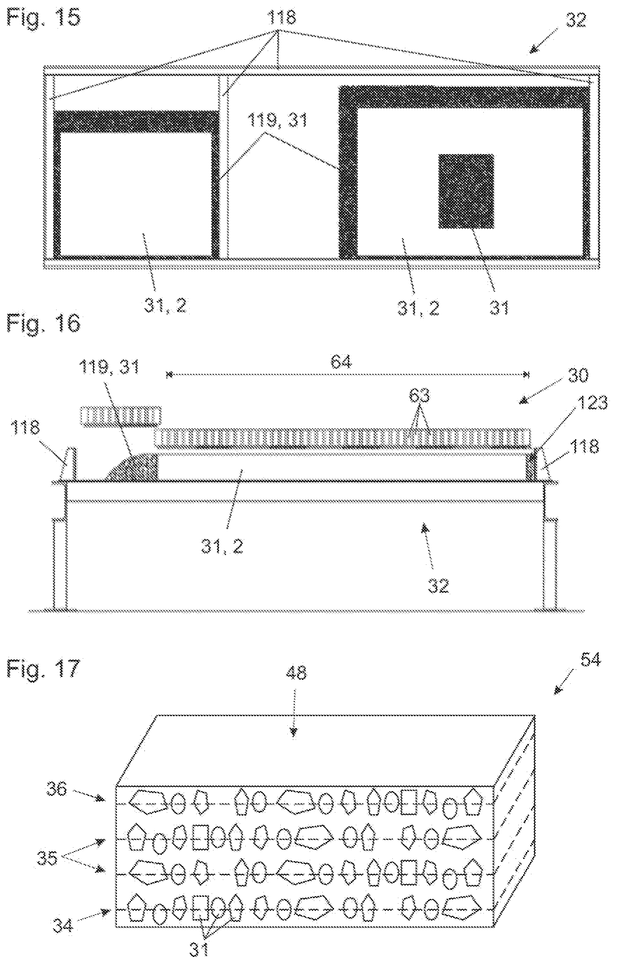

FIG. 15 shows a further embodiment of a production pallet 32 with two printed regions. Limits 118 are present which can be formed fixed, displaceable or height-adjustable.

A lateral limit of a printed prefabricated component, however, need not necessarily be effected by limits in the form of separate limit elements. A lateral limit can also be formed from the at least one particulate aggregate 31 in the form of debris cones 119 in the course of a printing process.

FIG. 16 shows a further embodiment of a production pallet 32 and a layer depositing device 30 in a schematically represented cross-sectional view from the side.

In order to generate a side face 123 that is as smooth as possible of a prefabricated component to be printed, a nozzle distance of a printhead 1 to a lateral limit can be chosen to be as small as possible. In the ideal case, an almost formwork-smooth side face 123 can be generated in this way.

It is appropriate that the layer depositing device 30, as in the case represented, has several segments 63, which are individually activatable and deactivatable in order to achieve a predetermined, i.e. variably settable, layer depositing width 64. In this connection, it is appropriate that the layer depositing device 30 has inner and/or outer partitions.

It can analogously be provided that the print bar is formed in several parts and has individually activatable and deactivatable printheads 1 in order to achieve a predetermined printing width.

FIG. 17 shows a further embodiment of a concrete prefabricated component 54, produced according to a method described above. Layers 34, 35, 36 of the at least one particulate aggregate 31 are deposited on the production pallet 32 by the at least one layer depositing device 30. The layers 34, 35, 36 are indicated by dashed lines. A predetermined dose 49 of the water-binder mixture 2 is delivered at locally predetermined regions 33 of the layers 34, 35, 36 of the at least one aggregate 31 by the printhead 1.

In the concrete prefabricated component 54 represented, a predetermined dose 49 of the at least one water-binder mixture 2 is delivered at at least one locally predetermined region 33 of the printing platform 32 before a first layer 34 of the at least one aggregate 31 is deposited on the production pallet 32, and a predetermined dose 49 of the water-binder mixture 2 is delivered at at least one locally predetermined region 33 of the last layer 36 of the at least one aggregate 31 after a last layer 36 of the at least one aggregate 31 has been deposited. In this way, very smooth surfaces 48 which are smooth in a similar way to the surfaces that can be generated in the conventional manner by formworks can be generated on the top and bottom of the concrete prefabricated component 54.

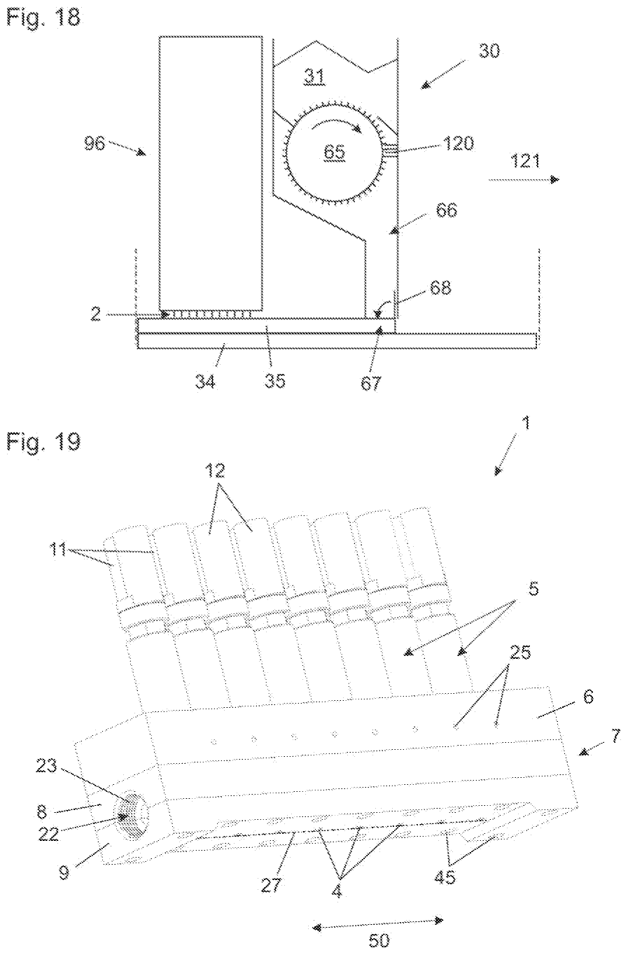

FIG. 18 shows an embodiment of a print bar 30 and a layer depositing device 30 of a 3D printing station in a schematically represented cross-sectional view from the side.

The layer depositing device 30 comprises a metering roller 65, via which the at least one particulate aggregate 31 can be applied to the at least one production pallet 32.

A removal device 120, e.g. in the form of a brush, is provided, with which the at least one particulate aggregate 31 can be removed, metered, from the metering roller 65.

The metering roller 65 can also be formed in several parts.

A depositing funnel 66 is provided, which can be made to vibrate with at least one vibration device, with the result that a twisting of coarse-grained material can be prevented.

The layer depositing device 30 comprises at least one delivery opening 67 and at least one metering flap 68, with which the at least one delivery opening 67 can be closed to different extents, with the result that a delivered quantity of the at least one particulate aggregate 31 can be metered.

The movement direction of the print bar 30 and the layer depositing device 30 is labeled with the reference number 121.

The print bar 30 and the layer depositing device 30 or at least a part of the layer depositing device 30 can be raised and lowered individually and independently of each other.

FIG. 19 and the subsequent figures show a schematically represented embodiment of a printhead 1 for the controlled delivery of a water-binder mixture 2, comprising water and at least one hydraulic binder, in particular a cement-based binder, wherein the printhead 1 comprises a feed channel 3 for feeding the water-binder mixture 2 in, several outlet openings 4, which can be brought into fluid connection with the feed channel 3, and several valves 5, with which the outlet openings 4 can be opened and closed in a controlled manner, whereby a predetermined dose 49 of the water-binder mixture 2 can be delivered through the outlet openings 4.

The outlet openings 4 are arranged equidistant on a line 27.

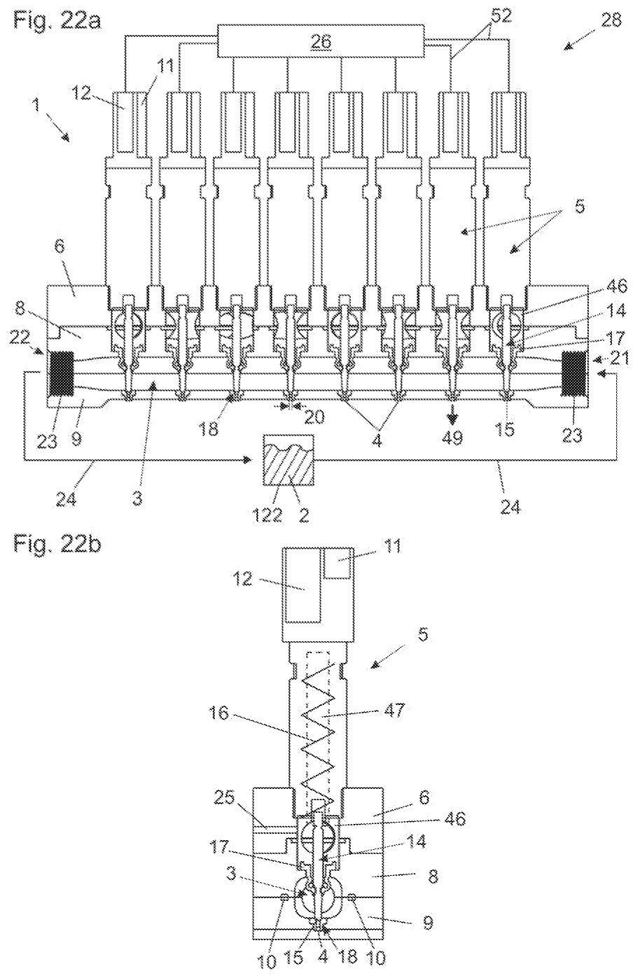

The valves 5 are formed as electropneumatic valves and in each case have a compressed-air connection 11 and an electrical connection 12. Via the compressed-air connection 11, the valve 5 can be supplied with compressed air, with which a cylinder 47, which is connected in a movement-coupled manner to a valve rod 14, can subsequently be actuated, cf. also FIG. 22b.

The valves 5 in each case have a valve rod 14, preferably made of at least one hard metal, preferably adjustable over an adjusting range 13 of between 0.5 and 1.5 mm. The adjusting range 13 is represented in FIG. 24b.

The valve rods 14 can, as in the case represented, have a free end 15, which is formed in the shape of a spherical head.

The valves 5 can comprise at least one return spring 16, preferably wherein the at least one return spring 16 is formed such that the allocated outlet opening 4 can be closed with a closing force of between 10 and 50 N, particularly preferably with a closing force of between 20 and 40 N. Such a return spring is represented schematically in FIG. 22b.

The valves 5 can have a bearing 46 for the valve rod 14, wherein the bearing 46 can, as in the case represented, be formed in the shape of a sleeve. The bearing 46 surrounds the valve rod 14 and the valve rod 14 moves relative to the bearing 46.

For each valve 5 a, preferably replaceable, seal membrane 17 is provided, which seals the valve rod 14 against a penetration of the water-binder mixture 2. In the specific case, the seal membrane is arranged in a sealing manner between the valve rod 14 and the bearing 46.

The printhead 1 has several air-exhaust channels 25, with which a pressure equalization can be generated for the valve rods 14, cf. also FIG. 22b. Without the air-exhaust channels 25, there is the danger that a negative pressure, by which a part of the water-binder mixture 2 is sucked in and thereby penetrates into the valve 5, will develop on the side of the seal membrane 17 facing the valve 5.

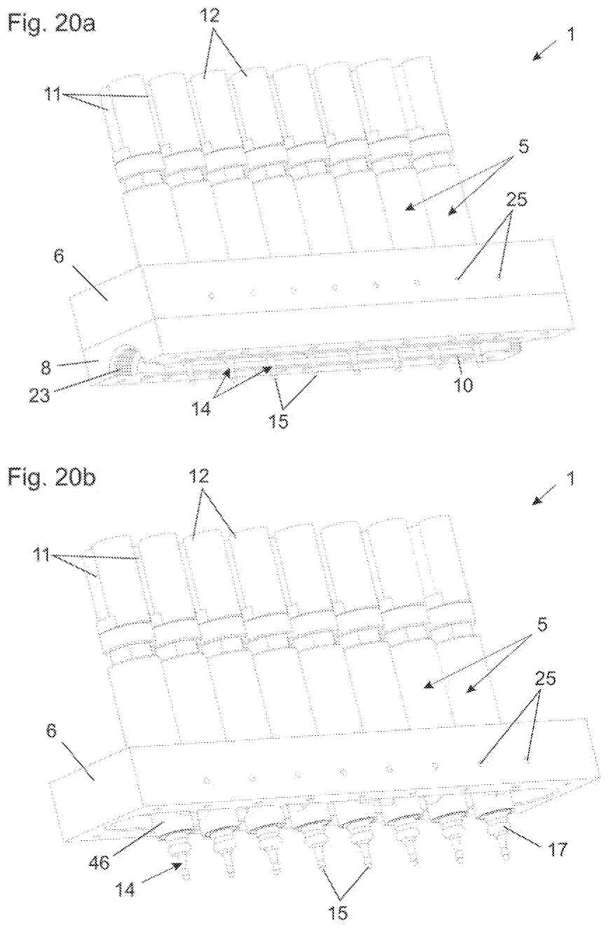

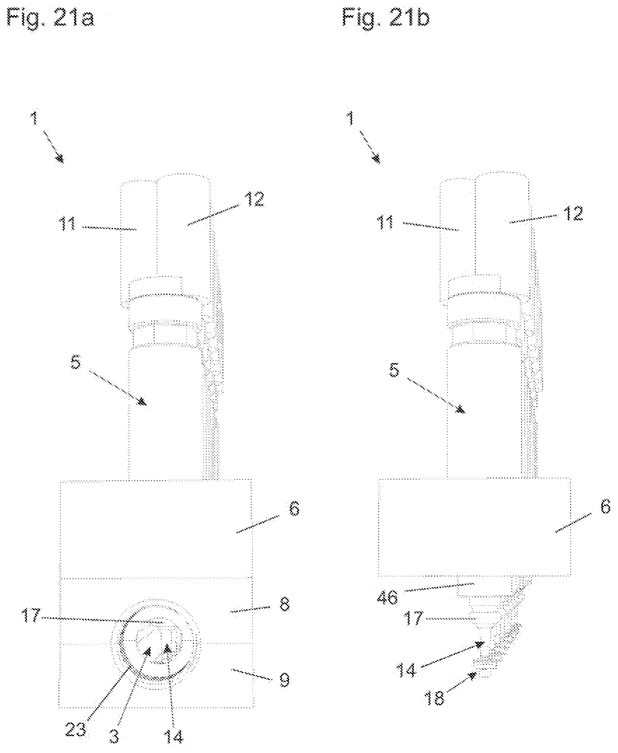

With reference to FIGS. 20a and 20b, it is particularly easily recognizable that the printhead 1 has a base body 6, on which the valves 5 are arranged, and a removable body 7 releasably connectable to the base body 6, wherein the outlet openings 4 and the feed channel 3 are arranged on the removable body 7. For the releasable connection of the removable body 7 on the base body 6, fastening means 45 can be provided (cf. FIG. 19), which can, as in the case represented, be formed as screws which engage in threads which are formed in the base body 6.

The removable body 7 consists of at least one acid-resistant plastic, preferably selected from a group consisting of PE, PVC, POM, PTFE and mixtures thereof and comprises at least one injection-molded part.

The removable body 7 has two partial bodies 8, 9 releasably connectable to each other, preferably wherein a seal 10 is arranged between the two partial bodies 8, 9 (cf. FIGS. 20a and 22b).

FIG. 22a shows a schematically represented embodiment of an arrangement 28 with a water-binder mixture 2, comprising water and at least one hydraulic binder, in particular a cement-based binder, and a printhead 1 for the controlled delivery of the water-binder mixture in a cross-sectional view along a cross-sectional plane parallel to a longitudinal axis 50 of the printhead 1. The longitudinal axis 50 is drawn in by way of example in FIG. 2.

The printhead 1 is formed according to the previously described preferred embodiment.

The at least one hydraulic binder is selected from a group consisting of Portland cement, calcium aluminate cement, calcium sulfoaluminate cement and mixtures thereof.

The water-binder mixture 2 comprises an additive in the form of a superplasticizer.

The feed channel 3 has an inlet opening 21 for the water-binder mixture 2, wherein the feed channel 3 has an outlet opening 22 lying opposite the inlet opening 21. The inlet opening 21 and the outlet opening 22 in each case have a thread 23 for the connection of a fluid line 24.

The water-binder mixture 2 can be arranged in an intermediate tank 122. The fluid lines 24 connect the intermediate tank 122 to the feed channel 3 of the printhead 1.

A control and/or regulating device 26 is provided, with which the valves 5 of the printhead 1 can be controlled. The control and/or regulating device 26 is connected in each case to the electrical connection 12 of the valves 5 via wires 52.

By the arrangement 28, a method for the controlled delivery of a water-binder mixture 2, comprising water and at least one hydraulic binder, in particular a cement-based binder, can be carried out, wherein the method comprises the following method steps: the water-binder mixture 2 is fed to the outlet openings 4 of printhead 1 via the feed channel 3 of the printhead 1, preferably with a pressure of between 0.1 and 2.0 bar, and the outlet openings 4 are opened and closed in a controlled manner by the valves 5 of the printhead 1 and a predetermined dose 49 of the water-binder mixture 2 is thereby delivered through the outlet openings 4.

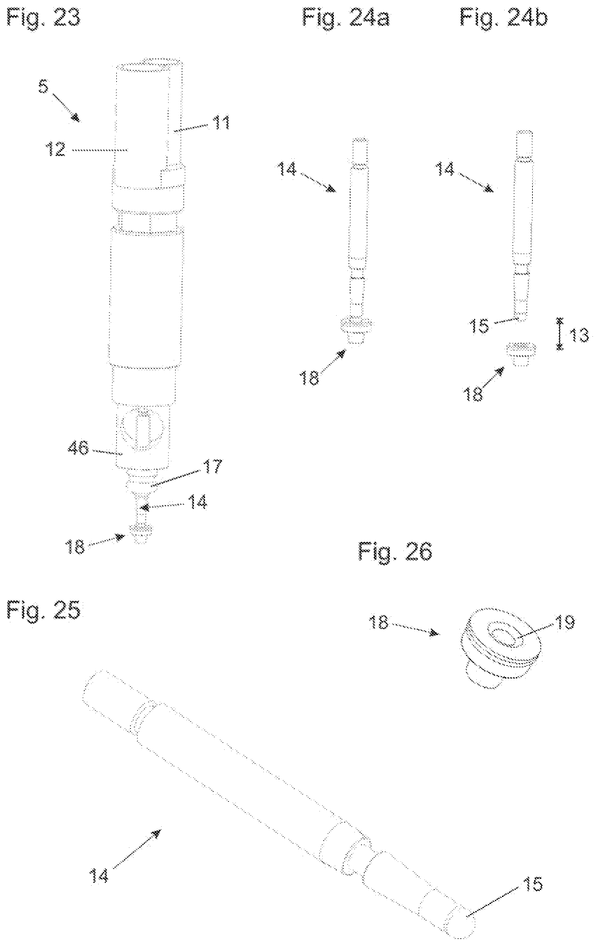

FIGS. 23, 24a, 24b, 25 and 26 show details of an embodiment of a valve 5 of the printhead 1 for the controlled delivery of a water-binder mixture 2 as well as a nozzle body 18 cooperating with the valve rod 14 of the valve 5, in which the outlet opening 4 is formed. The diameter 20, cf. FIG. 22a, of the outlet opening 4 is between 0.5 and 2.0 mm.

The nozzle body 18 is formed of at least one hard metal or ceramic, and has an inclined contact surface 19 for a free end 15 of the valve rod 14 of the valve 5. The inclined contact surface 19 can, as in the case represented, be formed in the shape of a funnel.

1. Method for producing a prefabricated 3D-printed part, preferably a concrete prefabricated component, for the construction industry, comprising the following method steps:
in a first method step at least one layer of at least one particulate aggregate is deposited on a production pallet by means of at least one layer depositing device,
in a second method step a predetermined dose of at least one binder or at least one water-binder mixture, comprising water and at least one hydraulic binder, in particular a cement-based binder, is delivered at at least one locally predetermined region of the at least one layer of the at least one aggregate by means of at least one printhead,
wherein
in a third method step at least one reinforcement is arranged, by means of at least one reinforcement depositing device, at least in regions on and/or in at least the at least one locally predetermined region, at which the predetermined dose of the at least one binder or the at least one water-binder mixture was delivered in the course of the second method step, wherein in the course of the third method step the reinforcement is sunk, preferably by pressing, shaking and/or vibration, at least in regions into the locally predetermined region of the at least one layer of the at least one particulate aggregate, in which the predetermined dose of the at least one binder or the at least one water-binder mixture was delivered.

2. The method according to claim 1, wherein in the course of the third method step at least one reinforcement is arranged in the form of a reinforcement mesh, preferably wherein
the reinforcement mesh is manufactured from steel and/or plastic, and/or
the reinforcement mesh is welded together from individual rods and/or at least one lattice girder, and/or
comprises fiber rods.

3. The method according to claim 1, wherein in the course of the third method step at least one reinforcement is arranged in the form of fibers, preferably glass fibers.

4. The method according to claim 1, wherein in the course of the third method step at least one reinforcement is arranged in the form of at least one individual rod, preferably provided by means of at least one straightening machine.

5. The method according to claim 1, wherein the at least one reinforcement is produced in a further method step, which is effected before the third method step, in at least one reinforcement welding device, which is preferably formed as a mesh welding system and/or as a lattice girder welding system, preferably wherein the production is effected when needed and/or CAD-controlled and/or with a batch size of 1.

6. The method according to claim 1, wherein the first and second method steps are repeated at least once after the third method step, and/or the first and second method steps are carried out in reverse order.

7. The method according to claim 1, wherein in the course of the second method step at least one water-binder mixture, comprising water and at least one hydraulic binder, in particular a cement-based binder, is delivered, and wherein the dose of the at least one water-binder mixture delivered is large enough that a liquefaction at least in regions is achieved at the at least one locally predetermined region of the at least one layer of the at least one aggregate.

8. (canceled)

9. The method according to claim 1, wherein in the course of the third method step the at least one reinforcement is arranged such that the at least one reinforcement has a lateral protrusion beyond a side of the at least one layer of the at least one particulate aggregate.

10. The method according to claim 1, wherein in a further method step unbound particulate aggregate is removed, preferably extracted, at least in one region.

11. The method according to claim 10, wherein in a further method step at least one insulation material is deposited by means of at least one further layer depositing device in the region in which the unbound particulate aggregate was removed.

12. The method according to claim 1, wherein
a predetermined dose of the at least one water-binder mixture is delivered at at least one locally predetermined region of the printing platform before a first layer of the at least one aggregate has been deposited on the production pallet, and/or
a predetermined dose of the water-binder mixture is delivered at at least one locally predetermined region of the last layer of the at least one aggregate after a last layer of the at least one aggregate has been deposited.

13. The method according to claim 1, wherein prefabricated parts in the form of wall elements for buildings are produced by means of the method.

14. Plant for carrying out the method according to claim 1, comprising
at least one 3D printing station with at least one layer depositing device for depositing, in layers, at least one particulate aggregate on the at least one production pallet and at least one printhead for the controlled delivery of at least one binder or at least one water-binder mixture, comprising water and at least one hydraulic binder, in particular a cement-based binder, at at least one locally predetermined region of the production pallet and/or a layer of the at least one aggregate deposited on the production pallet by the at least one layer depositing device, and
at least one reinforcement depositing device, with which at least one reinforcement can be arranged at least in regions on and/or in at least the at least one locally predetermined region, at which the predetermined dose of the at least one binder or the at least one water-binder mixture was delivered in the course of the second method step, whereby the plant is configured to sink the reinforcement, preferably by pressing, shaking and/or vibration, at least in regions into the locally predetermined region of the at least one layer of the at least one particulate aggregate, in which the predetermined dose of the at least one binder or the at least one water-binder mixture was delivered.

15. The plant according to claim 14, wherein the at least one reinforcement depositing device has at least one carrier and at least one gripper, which is mounted movably along the at least one carrier.

16. The plant according to claim 14, wherein the plant comprises at least one straightening machine and/or at least one reinforcement welding device, preferably wherein the at least one reinforcement welding device is formed as a mesh welding system and/or as a lattice girder welding system.
